(19) United States
(12) Patent Application Publication
(10) Pub. No.: US 2012/0300493 A1
(43) Pub. Date: Nov. 29, 2012

(54) Light Source Module and a Backlight Module Using the Same

(75) Inventors: Kuangyao Chang, Shenzhen City (CN); Kuojun Fang, Shenzhen City (CN); Qian Cao, Shenzhen City (CN)

(73) Assignee: Shenzhen China Star Optoelectronics Technology Co.,LTD., Shenzhen City, Guangdong (CN)

(21) Appl. No.: 13/376,586

(22) PCT Filed: Jul. 28, 2011
(86) PCT No.: PCT/CN2011/077767

§ 371 Date: Dec. 6, 2011

(30) Foreign Application Priority Data
May 26, 2011 (CN) 201110138952.6

(51) Int. Cl. F21V 13/04

(52) U.S. Cl. 362/602; 362/235

(57) ABSTRACT

A light source module including light sources and secondary optical lens is proposed. The secondary optical lens includes an incident curved surface, an emitting curved surface, and a bottom of prism. The incident curved surface has a concave area defined as a cavity where the light source is disposed. A light beam generated by the light source is emitted to the inside of the secondary optical lens through the incident curved surface. The light beam is emitted outwards through the emitting curved surface after being reflected by the prism microstructures on the bottom of prism. The light beam reflected by the emitting curved surface can be emitted to the inside of the secondary optical lens again by using the prism microstructures. Therefore, the light source module can reduce the scattering amount of the light beam, thereby improving the utilization of the light beam generated by the light source.

### BACKGROUND OF THE INVENTION

1. Field of the Invention

The present invention relates to a light source module and a backlight module, and more particularly, to a light source module for reducing light scattering and enhancing use efficiency of light sources and a backlight module using the same.

2. Description of the Prior Art

Owing to their low-profile, thin, and lightweight features, liquid crystal display (LCD) devices have replaced cathode ray tubes (CRTs) in many applications and become the mainstream display devices in recent years. LCD screens are widely used in electronic devices such as mobile phones, personal digital assistants (PDAs), digital cameras, computer screens, notebook screens, etc.

An LCD device comprises a backlight module and an LCD panel. The backlight module is used for supplying light for the LCD device, so that images can be displayed on the LCD panel using the light. Traditionally, fluorescent tubes are used as light sources provided by the backlight module but have been gradually being replaced by light emitting diodes (LEDs) recently. This is because fluorescent tubes are much bulkier than LEDs, which does not conform to the overall trend of lightweight LCD devices. This replacement greatly reduces the thickness and the weight of the backlight module, which reduces the size and the thickness of the LCD devices.

According to the distribution of light sources provided by a backlight module, there are two main types of configuration for backlight sources: direct-light type and side edge type. The side edge backlight source technology sets the LED chips at sides of the LCD panel; the direct-light backlight technology sets the LED chips at the back of the LCD panel evenly serving as light sources, so that the backlight can be distributed across the LCD panel evenly, creating more delicate and more lifelike images. But it is necessary to use a large number of LED chips in the direct-light backlight source technology, which is a challenge to LCD manufacturers who strive to reduce the number of LEDs while without sacrificing the uniformity of luminance. As generally known in the industry, a certain level of radiation pattern/intensity distribution of LEDs needs to be achieved before a predetermined uniformity of luminance is acquired. However, the number of LEDs is in inverse proportion to the light mixing distance basically. In other words, the number of LEDs has to be increased to satisfy the predetermined uniformity of luminance whenever the light mixing distance is shortened.

Traditionally, LED emission intensity distribution is usually a Lambertian intensity distribution. The most luminous flux is roughly distributed within a sector region with an angle of ±60 degrees, where the angle θ is defined as the included angle between a light beam and a normal line of an LED emitting surface.

Referring to FIG. 1 to FIG. 3, FIG. 1 shows a perspective view of a light source unit 200 according to the conventional technology, FIG. 2 shows a top view of the light source unit 200 in FIG. 1, and FIG. 3 is a cross section view of the light source unit 200 along a line e-e′ in FIG. 2. In general, the light source unit 200 comprises an LED 210, a secondary optical lens 220, and a reflector 230. To solve mutual constraint dependencies between the number of LEDs and the light mixing distance, a feasible solution is using the secondary optical lens 220 to alter the light intensity distribution in airspace of LEDs. In other words, light energy can be distributed over a wider area through the secondary optical lens 220. For example, if an angle θ becomes ±75°, it is possible that the uniformity of luminance maintains better while the number of LEDs is reduced.

Continuing referring to FIG. 3, the secondary optical lens 220 comprises a bottom a, an incident curved surface b, and an emitting curved surface c. A light beam is generated by the LED 210 disposed on the bottom a of the secondary optical lens 220, emitted to the secondary optical lens 220 through the incident curved surface b, and sent outwards through the emitting curved surface c. Because the light beam is refracted twice (i.e., the refraction of the incident curved surface b of the secondary optical lens 220 and the refraction of the emitting curved surface c of the secondary optical lens 220), the emitting angle of the light beam is different from the emitting angle of the light beam generated by the LED 210. Such an arrangement allows the luminous flux θ of the LED 210 to be higher.

As a light beam 1 shows, the light beam 1 generated by the LED is emitted to the inside of the secondary optical lens 220 through the incident curved surface b; then, the light beam 1 is reflected by the emitting curved surface c of the secondary optical lens 220; then, the light beam 1 is emitted to the bottom a at a small angle α; finally, the light beam 1 is emitted outside from the bottom a. However, such a design decreases the use efficiency of the light beam because the scattering effect of the reflector 230 causes the light beam reflected to the reflector 230 to be scattered. The light beam may be emitted to the reflector 230 by the bottom a, or may be reflected to the reflector 230 by the incident curved surface b (not shown in FIG. 3 because the proportion is small). Thus, the light beam reflected by the reflector 230 cannot be fully utilized; instead, the most portion of the reflected light beam is scattered.

Therefore, there is a need for a backlight module which is able to reduce light scattering more effectively, thereby enhancing use efficiency of light sources, in order to solve the above-mentioned problem occurring in the prior art.

### SUMMARY OF THE INVENTION

Accordingly, the present invention has been made to solve the above-mentioned problem occurring in the prior art, and an object of the present invention is to provide a light source module which can reduce light leakage and thereby can enhance use efficiency of light sources, and a backlight module using the same.

According to the present invention, a backlight module comprises a light guide plate, at least one light source, a circuit board bearing the at least one light source, and at least one secondary optical lens. The secondary optical lens is disposed on the light source and comprises a bottom, an incident curved surface, and an emitting curved surface. The incident curved surface has a concave area defined as a cavity. The light source is disposed inside the cavity. A plurality of prism microstructures are formed on the bottom. A light beam generated by the light source is emitted to the inside of the secondary optical lens through the incident curved surface, and then is emitted out of the secondary optical lens through the emitting curved surface. The light beam reflected by the emitting curved surface is emitted to the inside of the secondary optical lens again by reflection of the prism microstructures.

In one aspect of the present invention, a flat zone is disposed on the bottom of prism and is located between the incident curved surface and the bottom, and no prism microstructures are disposed on the flat zone.

In another aspect of the present invention, each prism microstructure is a bar-like shape, and an extended direction of each of the plurality of prism microstructures and an extended direction of a longer side of the circuit board form an included angle which is between 87 and 93 degrees.

In still another aspect of the present invention, a vertex angle of each of the plurality of prism microstructures is between 88 and 92 degrees.

In yet another one aspect of the present invention, a cross section of each of the plurality of prism microstructures is in the shape of an isosceles triangle. A refractive index of materials which each of the plurality of prism microstructures is made of is between 1.45 and 1.7.

In yet another of the present invention, an emitting surface of the light source is higher than the bottom or is at least parallel to the bottom.

According to the present, a light source module comprising at least one light source, a circuit board bearing the at least one light source, and at least one secondary optical lens is provided. The secondary optical lens comprises a bottom, an incident curved surface, and an emitting curved surface. The incident curved surface has a concave area defined as a cavity. The light source is disposed inside the cavity. An emitting surface of the light source is higher than the bottom or is at least parallel to the bottom. The light source module further comprises a prism element comprising a plurality of prism microstructures adhered to the bottom. A light beam generated by the light source is emitted to the inside of the secondary optical lens through the incident curved surface. The light beam traveling to the bottom of the secondary optical lens is reflected by the plurality of prism microstructures and is emitted out of the secondary optical lens through the emitting curved surface.

According to the present, a light source module comprising at least one light source, a circuit board bearing the at least one light source, and at least one secondary optical lens is provided. The secondary optical lens comprises a bottom, an incident curved surface, and an emitting curved surface. The incident curved surface has a concave area defined as a cavity. The light source is disposed inside the cavity. An emitting surface of the light source is higher than the bottom or is at least parallel to the bottom. The light source module further comprises a plurality of prism microstructures disposed on the bottom. A light beam generated by the light source is emitted to the inside of the secondary optical lens through the incident curved surface. The light beam traveling to the bottom of the secondary optical lens is reflected by the plurality of prism microstructures and is emitted out of the secondary optical lens through the emitting curved surface.

Compared with the prior art, the backlight module according to the present invention utilizes a secondary optical lens comprising a bottom of prism. The light beam reflected by an emitting curved surface of the secondary optical lens can be reflected to the secondary optical lens by the bottom of prism again. In this way, the light beam which would have been scattered can be saved and well used by using the bottom of prism. Accordingly, the backlight module according to the present invention is good at enhancing use efficiency of light sources.

These and other features, aspects and advantages of the present disclosure will become understood with reference to the following description, appended claims and accompanying figures.

### BRIEF DESCRIPTION OF THE DRAWINGS

FIG. 1 shows a perspective view of a conventional light source unit.

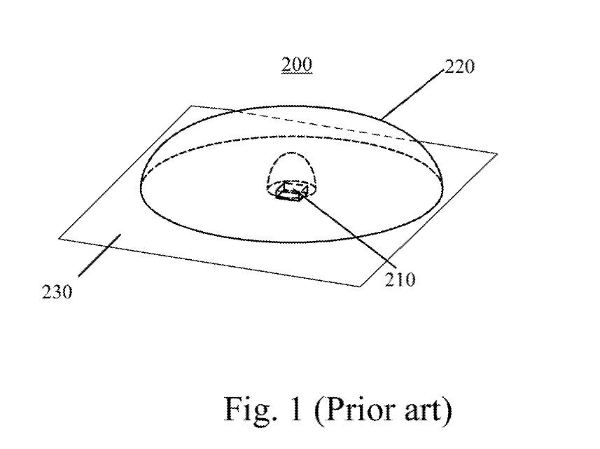

FIG. 2 shows a top view of the light source unit in FIG. 1.

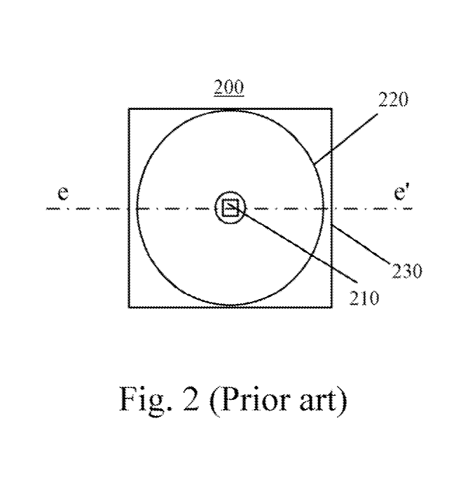

FIG. 3 is a cross section view of the light source unit along a line e-e′ in FIG. 2.

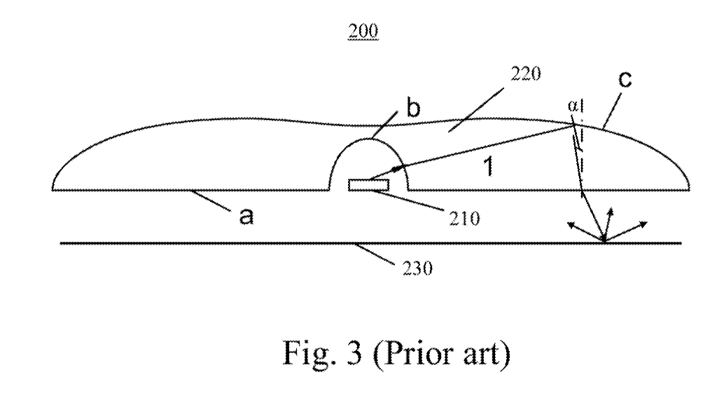

FIG. 4 shows a schematic diagram of a backlight module according to the present invention.

FIG. 5 shows a top view of the light source module in FIG. 4.

FIG. 6 shows a perspective view of a light source unit in the backlight module according to a first embodiment of the present invention.

FIG. 7 shows a bottom view of the light source unit in FIG. 6.

FIG. 8 is a cross section view of the light source unit along a line z-z′ in FIG. 7.

FIG. 9 is a cross section view of a light source unit in the backlight module according to a second embodiment.

FIG. 10 shows a top view of the light source unit in the backlight module according to a third embodiment of the present invention.

FIG. 11 is a cross section view of the light source unit along a line x-x′ in FIG. 10.

FIG. 12 is a cross section view of the light source unit along a line y-y′ in FIG. 10.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

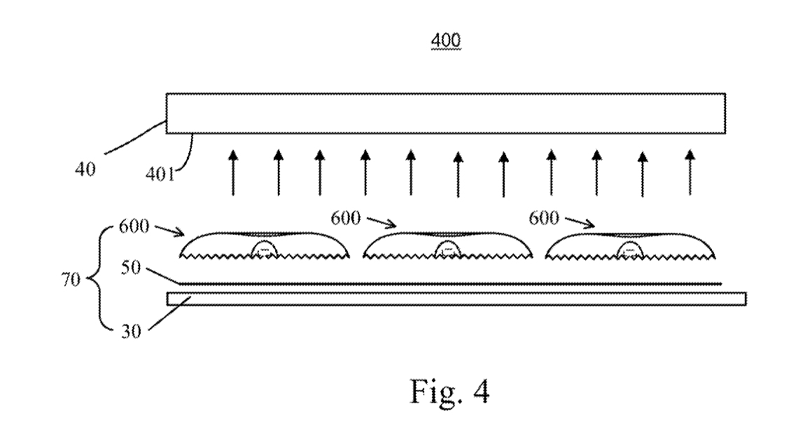

Referring to FIG. 4, FIG. 4 shows a schematic diagram of a backlight module 400 according to the present invention. The backlight module 400 comprises a light guide plate (LGP) 40 and a light source module 70. The light source module 70, disposed on the bottom of the backlight module 400, comprises a circuit board 30, a plurality of light source units 600 disposed on the circuit board 30, and a reflector 50 disposed on the circuit board 30. Optical elements such as the LGP 40, a diffusion sheet, and a polarizer film are overlapped and disposed on the plurality of light source units 600. The backlight module 400 is a direct-light type backlight module. The light source module 70 is placed under the LGP 40 and a light beam generated by the plurality of light source units 600 can be emitted inwards through an incident bottom 401 of the LGP 40.

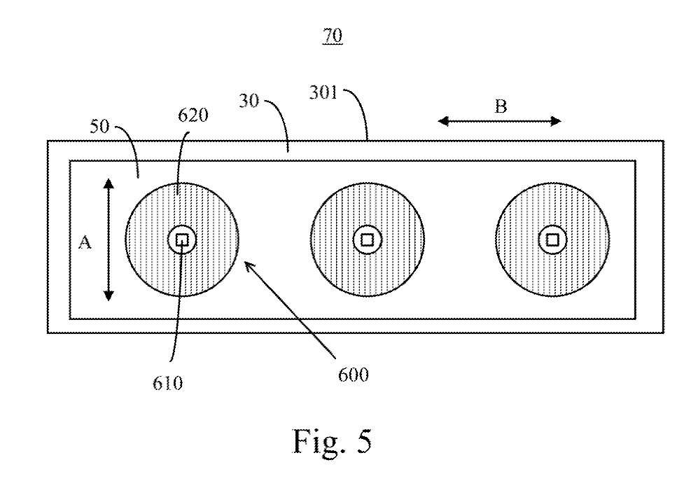

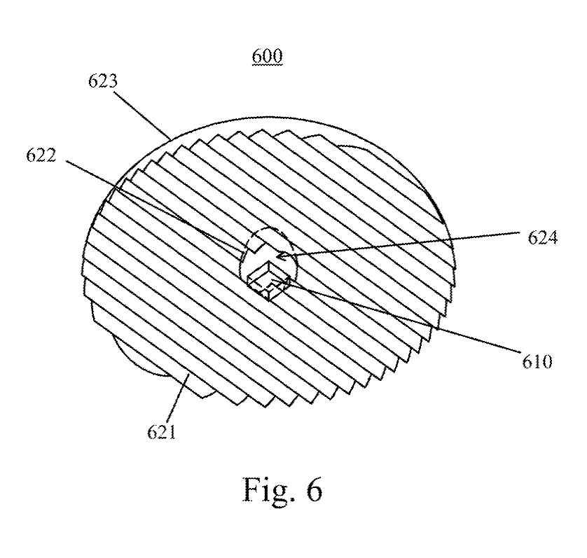

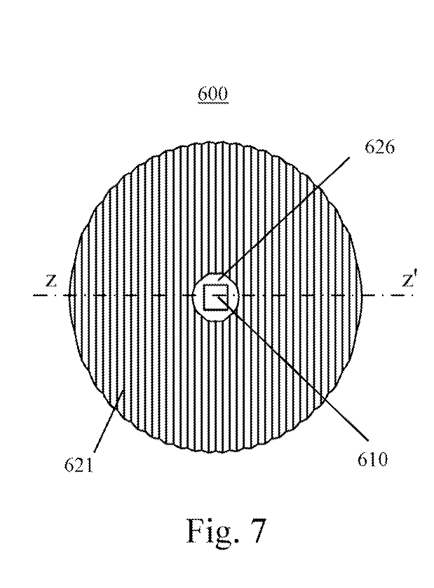

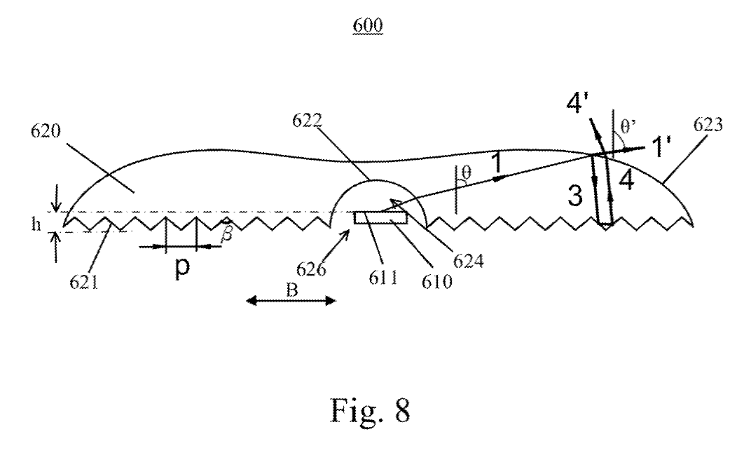

Referring to FIG. 5 to FIG. 8, FIG. 5 shows a top view of the light source module 70 in FIG. 4, FIG. 6 shows a perspective view of a light source unit 600 in the backlight module 400 according to a first embodiment of the present invention, FIG. 7 shows a bottom view of the light source unit 600 in FIG. 6, and FIG. 8 is a cross section view of the light source unit 600 along a line z-z′ in FIG. 7. The light source unit 600 comprises a light source 610 and a secondary optical lens 620. The light source 610 may be an LED or an organic light emitting diode (OLED). The secondary optical lens 620 comprises a prism bottom 621, an incident curved surface 622, and an emitting curved surface 623. The incident curved surface 622 is projected onto the prism bottom 621, and the projected area is defined as an opening 626. The incident curved surface 622 has a concave area defined as a cavity 624. As shown in FIG. 8, the light source 610 having an emitting surface 611 is disposed inside the cavity 624. The emitting surface 611 needs to be higher than the prism bottom 621. A distance h exists between the emitting surface 611 and the prism bottom 621. Or, the emitting surface 611 and the prism bottom 621 are in parallel at least; that is, h=0. The light beam generated by the light source 610 is emitted to the inside of the secondary optical lens 620 through the incident curved surface 622 and is emitted out of the secondary optical lens 620 through the emitting curved surface 623. Owing to the refraction of the incident curved surface 622 and the refraction of the emitting curved surface 623, the equivalent luminous flux of the light source 610 becomes higher. The emitting curved surface 623 encompasses the curved surface of the secondary optical lens 620.

It is notified that, a plurality of bar-like prism microstructures are formed on the prism bottom 621 of the secondary optical lens 620 of the light source unit 600 according to the present invention. The cross section of each of the plurality of prism microstructures is in the shape of an isosceles triangle. While the secondary optical lens 620 is formed, the prism bottom 621 can be formed simultaneously. In addition, as shown in FIG. 5, an angle between an extended direction A of the plurality of bar-like prism microstructures on the prism bottom 621 and an extended direction B of a longer side 301 of the circuit board 30 is in a range between 87 and 93 degrees. Preferably, the included angle is exactly 90 degrees.

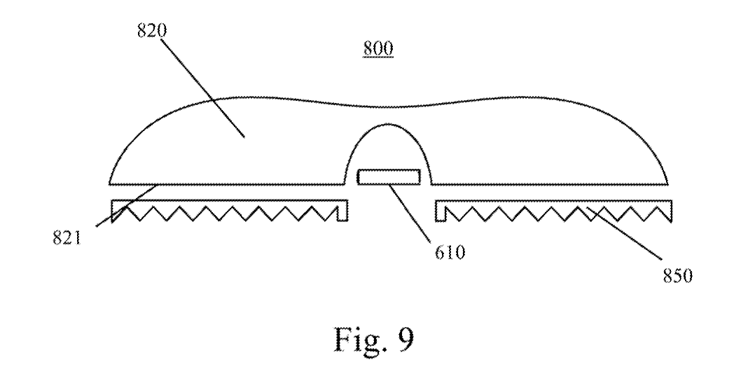

Referring to FIG. 9, FIG. 9 is a cross section view of a light source unit 800 in the backlight module 400 according to a second embodiment. The light source unit 800 and the light source unit 600 are roughly the same except that the light source unit 800 comprises a prism element 850 and a secondary optical lens 820. The secondary optical lens 820 has a flat bottom 821. The prism element 850 comprises a plurality of prism microstructures. The prism element 850 adheres to the lower side of the bottom 821 of the secondary optical lens 820. Any corresponding modifications and variations can be made without deviating from the scope of the invention.

As shown in FIG. 6 to FIG. 8, the secondary optical lens 620 according to present invention is a far cry from the conventional secondary optical lens 220. The prism bottom 621 of the secondary optical lens 620 comprises a plurality of prism microstructures. The function of the prism bottom 621 will be revealed in a subsequent statement.

Continuing referring to FIG. 8, the incident light beam 1 generated by the light source 610 is emitted to the inside of the secondary optical lens 620 through the incident curved surface 622 and is emitted outwards by the emitting curved surface 623. The incident light beam 1 refracted outwards is referred as the refracted light beam 1′. An included angle θ′ formed by the refracted light 1′ and the normal line is larger than the angle θ between the incident light beam 1 and the normal line. Therefore, the arrangement of the secondary optical lens 620 can increase the luminous flux.

On the other hand, while the incident light beam 1 is emitted to the emitting curved surface 623, some of the incident light beam 1 is reflected by the emitting curved surface 623 and becomes a reflected light beam 3 as shown in FIG. 8. The reflected light beam 3 undergoes two total internal reflections by the prism bottom 621 and is emitted into the secondary optical lens 620 again. Then, the reflected light beam 3 is emitted to the emitting curved surface 623 (like a light beam 4) and is emitted outwards through the emitting curved surface 623 (like a light beam 4′). In this way, the reflected light beam 3 can be prevented from being scattered. Because the reflected light beam 3 can be totally internally reflected by the plurality of prism microstructures, the possibility of scattering of the reflected light beam 3 is decreased, thereby enhancing use efficiency of the light source 610.

A less amount of light beam refracted by the prism bottom 621 and the light beam reflected by the incident curved surface 622 are refracted by the prism bottom 621 and then are emitted to the emitting curved surface 623 after being reflected by the reflector 50 (referring to FIG. 4) under the plurality of light source units 600.

It is notified that, the prism bottom 621 is preferably designed according to the present embodiment for the purpose that the plurality of prism microstructures of the secondary optical lens 620 is able to match the total internal reflection. For example, the cross section of each of the plurality of prism microstructures is in the shape of an isosceles triangle, so that the light beam can be reflected to the secondary optical lens 620 accurately. In addition, the vertex angle of each of the plurality of prism microstructures and materials which the plurality of prism microstructures are made of have to be modified so as to make sure that the incident angle of the reflected light beam 3 is large enough and that the refractive index of materials is large enough. Preferably, the vertex angle β of each of the plurality of prism microstructures is between 88 and 92 degrees; the refractive index of materials is between 1.45 and 1.7. The distance p between two vertexes of each of the plurality of prism microstructures can be a constant value. Similarly, the vertex angle β of each of the plurality of prism microstructures can be a constant value. Also, the distance p or the vertex angle β varies in a certain trend along the direction B (perpendicular to the extended direction A of the plurality of bar-like prism microstructures shown in FIG. 5). The plurality of prism microstructures may be made of polymethylmethacrylate (PMMA), poly carbonate (PC), or silicon for ensuring that the total internal reflection occurs. However, the above-mentioned design is not to limit the present invention. Operators can adjust materials which the plurality of prism microstructures are made of and the vertex angle of each of the plurality of prism microstructures as long as the total internal reflection occurs. Any corresponding modifications and variations can be made without deviating from the scope of the invention.

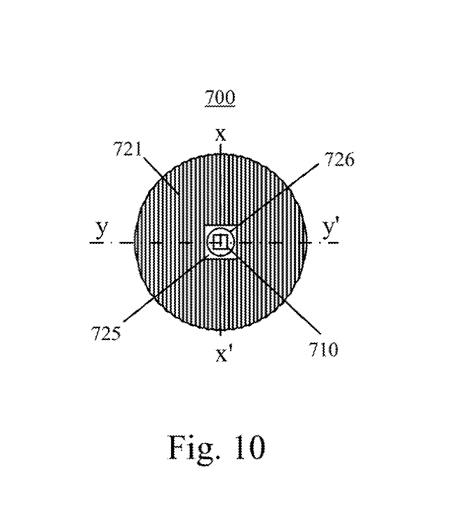

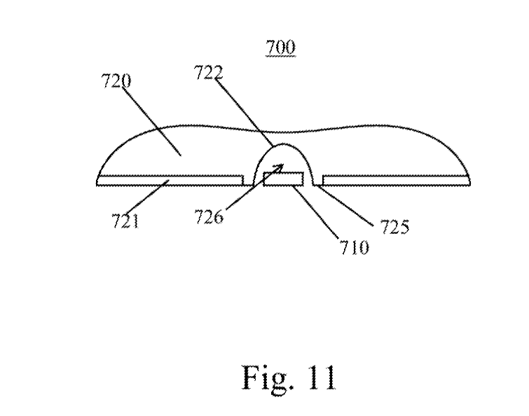

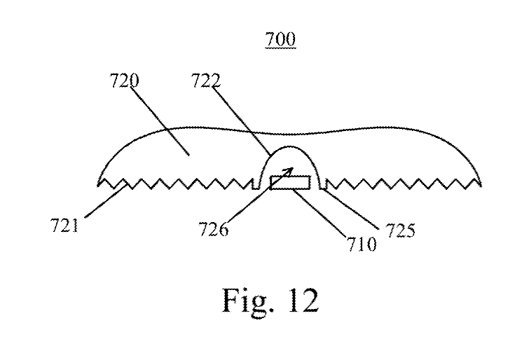

Referring to FIG. 10 to FIG. 12, FIG. 10 shows a top view of the light source unit 700 in the backlight module 400 according to a third embodiment of the present invention, FIG. 11 is a cross section view of the light source unit 700 along a line x-x′ in FIG. 10, and FIG. 12 is a cross section view of the light source unit 700 along a line y-y′ in FIG. 10. The light source unit 700 comprises a light source 710 and a secondary optical lens 720. The light source 710 and the secondary optical lens 720 according to the present embodiment have the same function as the light source 610 and the secondary optical lens 620 according to the first embodiment do, so no further details are released hereafter. Differing from the light source unit 600 according to the first embodiment, the light source unit 700 comprises the secondary optical lens 720 having a bottom of prism 721 comprising a flat zone 725. The flat zone 725, located on the bordering area of an incident curved surface 722 and the bottom of prism 721, may be square-shaped or circle-shaped. No prism microstructures are disposed on the flat zone 725. An opening 726 is formed when the incident curved surface 722 is projected onto the flat zone 725. The incident curved surface 722 is projected onto the middle of the flat zone 725 of the bottom of prism 721. The opening 726 is used for preventing the plurality of prism microstructures from blocking a light beam generated by the light source 710, or for preventing the light beam from being spayed out from slits of the plurality of prism microstructures. No prism microstructures are disposed on the bordering area of the incident curved surface 722 and the bottom of prism 721 from the cross section along the line x-x′ as shown in FIG. 11. Similarly, no prism microstructures are disposed on the bordering area of the incident curved surface 722 and the bottom of prism 721 of the secondary optical lens 720 as shown in FIG. 12.

It is understood that the bottom of prism 721 comprises the flat zone 725 and the opening 726 according to the second embodiment. However, neither the flat zone 725 nor the opening 726 is limited in size and shape according to the present invention. In other words, the shape and size of the opening 726 can be designed at will as long as the size and the shape of the flat zone 725 and the opening 726 are appropriate enough to allow the light beam generated by the light source 710 to be emitted inwards. Any corresponding modifications and variations can be made without deviating from the scope of the invention.

The light source unit 700 can also be used as a backlight source in the backlight module 400 according to another embodiment.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A backlight module, comprising a light guide plate, at least one light source, a circuit board bearing the at least one light source, and at least one secondary optical lens, the secondary optical lens being disposed on the light source and comprising a bottom, an incident curved surface, and an emitting curved surface, the incident curved surface having a concave area defined as a cavity, the light source disposed inside the cavity, a plurality of prism microstructures formed on the bottom, the backlight module being wherein a light beam generated by the light source is emitted to the inside of the secondary optical lens through the incident curved surface, and then is emitted out of the secondary optical lens through the emitting curved surface, wherein the light beam reflected by the emitting curved surface is emitted to the inside of the secondary optical lens again by reflection of the plurality of prism microstructures.

2. The backlight module of claim 1, wherein a vertex angle of each of the plurality of prism microstructures is between 88 and 92 degrees.

3. The backlight module of claim 1, wherein a cross section of each of the plurality of prism microstructures is in the shape of an isosceles triangle.

4. The backlight module of claim 1, wherein a refractive index of materials which each of the plurality of prism microstructures is made of is between 1.45 and 1.7.

5. The backlight module of claim 1, wherein each prism microstructure is a bar-like shape, and an extended direction of each of the plurality of prism microstructures and an extended direction of a longer side of the circuit board form an included angle which is between 87 and 93 degrees.

6. The backlight module of claim 1, wherein a flat zone is disposed on the bottom of prism and is located between the incident curved surface and the bottom, and no prism microstructures are disposed on the flat zone.

7. The backlight module of claim 6, wherein the flat zone is either square-shaped or circle-shaped.

8. The backlight module of claim 1, wherein an emitting surface of the light source is higher than the bottom or is at least parallel to the bottom.

9. A light source module, comprising at least one light source, a circuit board bearing the at least one light source, and at least one secondary optical lens, the secondary optical lens comprising a bottom, an incident curved surface, and an emitting curved surface, the incident curved surface having a concave area defined as a cavity, the light source disposed inside the cavity, an emitting surface of the light source being higher than the bottom or is at least parallel to the bottom, wherein the light source module further comprises a prism element comprising a plurality of prism microstructures adhered to the bottom, a light beam generated by the light source is emitted to the inside of the secondary optical lens through the incident curved surface, wherein the light beam traveling to the bottom of the secondary optical lens is reflected by the plurality of prism microstructures and is emitted out of the secondary optical lens through the emitting curved surface.

10. A light source module, comprising at least one light source, a circuit board bearing the at least one light source, and at least one secondary optical lens, the secondary optical lens comprising a bottom, an incident curved surface, and an emitting curved surface, the incident curved surface having a concave area defined as a cavity, the light source disposed inside the cavity, an emitting surface of the light source being higher than the bottom or is at least parallel to the bottom, wherein the light source module further comprises a plurality of prism microstructures disposed on the bottom, a light beam generated by the light source is emitted to the inside of the secondary optical lens through the incident curved surface, wherein the light beam traveling to the bottom of the secondary optical lens is reflected by the plurality of prism microstructures and is emitted out of the secondary optical lens through the emitting curved surface.

11. The light source module of claim 10, wherein a vertex angle of each of the plurality of prism microstructures is between 88 and 92 degrees.

12. The light source module of claim 10, wherein a cross section of each of the plurality of prism microstructures is in the shape of an isosceles triangle.

13. The light source module of claim 10, wherein a refractive index of materials which each of the plurality of prism microstructures is made of is between 1.45 and 1.7.

14. The light source module of claim 10, wherein each prism microstructure is a bar-like shape, and an extended direction of each of the plurality of prism microstructures and an extended direction of a longer side of the circuit board form an included angle which is between 87 and 93 degrees.

15. The light source module of claim 10, wherein a flat zone is disposed on the bottom of prism and is located between the incident curved surface and the bottom of prism, and no prism microstructures are disposed on the flat zone.
